(19) United States
(12) Patent Application Publication
(10) Pub. No.: US 2007/0211868 A1
(43) Pub. Date: Sep. 13, 2007

(54) Integrated System Providing Proxy Voice mail and Switching Functionality

(75) Inventors: Seenu Banda, Sunnyvale, CA (US); Sudhakar Valluru, San jose, CA (US)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: NetDevices, Inc., Sunnyvale (US)

(21) Appl. No.: 11/308,208

(22) Filed: Mar. 12, 2006

(51) Int. Cl. H04M 1/64

(52) U.S. Cl. 379/67.1

(57) ABSTRACT

Integrating proxy voice mail server (PVMS) and a switch/router into a single unit. According to another aspect, the PVMS downloads voice mail messages (related to users served in PVMS) when bandwidth utilization is below a pre-specified threshold. According to another aspect, previously recorded voice mail messages are uploaded to a central VMS (CVMS) also when the bandwidth utilization is below a pre-specified threshold. According to one more aspect, the voice mail messages stored locally in a PVMS are provided to a user (instead of from the CVMS) when the bandwidth utilization is above a threshold.

### BACKGROUND OF THE INVENTION

1. Field of the Invention

The present invention relates generally to telecommunication systems, and more specifically to a method and apparatus for providing network routing and voice mail services.

2. Related Art

Switching generally refers to forwarding of packets received on one interface to another interface. When the decision of the specific interface to forward on is based on (Internet Protocol) network address, the switching is referred to as routing. Devices commonly referred to as ATM switches, IP routers, gateways, provide switching functionality.

Voice mail service is often provided associated with telephone systems (connected by networks) using technologies such as Voice Over Internet Protocol (VOIP). Typically, when the phone line connecting to a telephone is busy or if a call is not answered at the telephone, the call is terminated at a voice mail server (VMS, using an IP network), which enables the caller to leave a voice mail message.

The message is recorded and stored in a voice mail box corresponding to the user. The user can then authenticate himself/herself over the network and retrieve the voice mail messages over telephone. Alternatively, the voice messages (in digitized form) may be received as files (e.g., by email), which can then be played at user's convenience.

Large organizations often employ a distributed approach in which several VMSs are employed as a cluster, and a front-end system then distributes each (voice-mail) access request among the VMSs in the cluster. Each VMS may store (or otherwise have access to) the voice messages stored for all of the users, and serves the access requests received from the front-end system. In other words, the front-end system determines the specific VMS on which the access request is processed.

In general, the cluster of VMSs in such environments are provided in locations (e.g., in the same local network of a central corporate location) connected by reliable and high speed communication links. However, there are several locations (such as branch offices) which are often connected by unreliable and/or low bandwidth links, and the cluster solution may not be suitable at least in such scenarios.

### BRIEF DESCRIPTION OF THE DRAWINGS

The present invention will be described with reference to the accompanying drawings, which are described below briefly. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating the details of an example environment in which various aspects of the present invention can be implemented.

FIG. 2 is a block diagram illustrating the details of integrated server in an embodiment of the present invention.

FIG. 3 is a flowchart illustrating the manner in which a PVMS may download message according to an aspect of present invention.

FIG. 4 is a flowchart illustrating the manner in which integrated server provides voice mail messages to the users according to an aspect of present invention.

FIG. 5 is a block diagram depicting the details of integrated server in an embodiment of the present invention.

FIG. 6 is a block diagram illustrating the details of a system in which various aspects of the present invention are operative by execution of software instructions.

### DETAILED DESCRIPTION OF THE PREFERRED EMBODIMENTS

### 1. Overview and Discussion of the Invention

An integrated system according to an aspect of the present invention provides both proxy voice mail service (PVMS) and switching functionalities. The PVMS operates as a backup server when a central VMS (CVMS) is deemed to be unavailable. Such an integrated system can be conveniently used at locations such as enterprise branch office (EBO) to reduce the number of devices (and thus reduce cost/complexity).

Another aspect of the present invention monitors the bandwidth utilization and downloads voice mail messages (corresponding to the users served by the PVMS) from a CVMS when the bandwidth utilization is low. As a result, messages may be downloaded more frequently, thereby enhancing the probability that the user will have access to the latest voice mail messages (even if the communication links to CVMS are down).

One more aspect of the present invention provides voice mail messages from the PVMS (instead of CVMS) if the bandwidth utilization is high when a user wishes to access the messages. As a result, retrieval of voice mail messages may not cause additional overhead on the communication links during periods of high bandwidth utilization. Such a feature is particularly important in EBO type environments where multiple applications/systems may share limited bandwidth.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well_known structures or operations are not shown in detail to avoid obscuring the features of the invention.

### 2. Example Environment

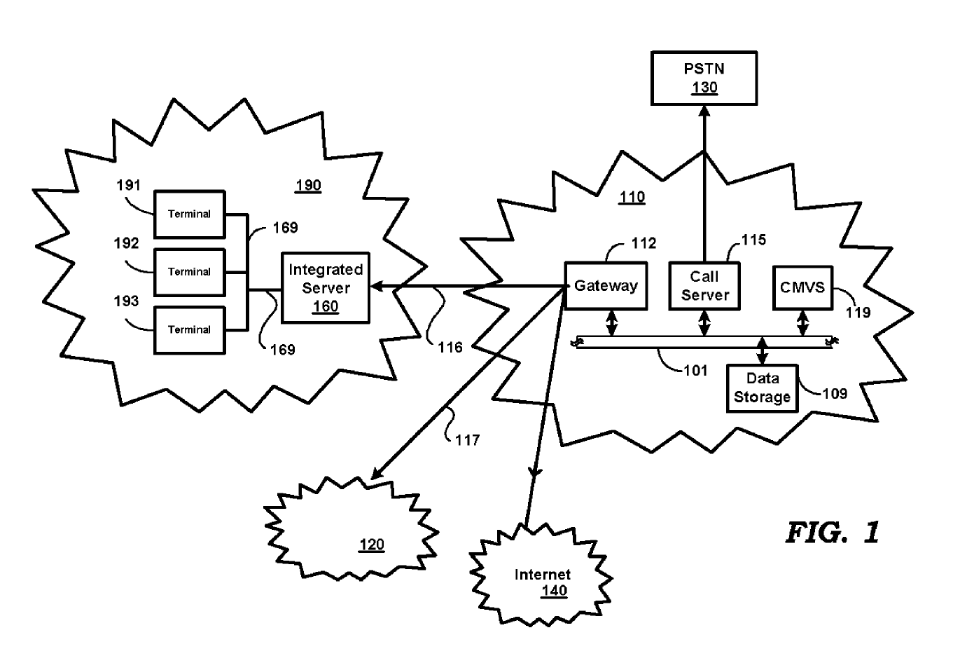

FIG. 1 is a block diagram illustrating the details of an example environment in which various aspects of the present invention can be implemented. The environment is shown containing gateway 112, call server 115, CVMS 119 and data storage 109 located in corporate premises 110, terminals 191-193 and integrated server 160 located in enterprise branch office (EBO) 190, another EBO 120, Internet 140, and PSTN 130. Each block is described in further detail below.

It is helpful to appreciate that corporate premises 110 provides/extends various services such as email, voice mail, connections to PSTN 130 (and other EBOs), etc. to EBOs 190 and 120 using communication links 116 and 117 respectively. EBO 120 also may contain systems similar to EBO 190, and the description is not repeated in the interest of conciseness. Only two EBOs are shown connected to corporate premises 110 for conciseness however, many such EBOs may be connected to cooperates premises 110.

Gateway 112 provides the IP connectivity between systems located in corporate premises 110 and the systems located in EBO 120/190, and Internet 140. The packets form the basis for call signaling (establishment, termination, etc.) and the later data transfer (representing voice signals) of a voice call.

Call server 115 may receive a call request from a caller terminal through PSTN 130, EBO 190 or internet 140, and establishes a call session between the caller terminal and the called terminal using signaling protocols such as SIP etc. However, if the call connection/session is not established due to reasons such as called party is busy or not responding or not reachable, call server 115 terminates the call on CVMS 119. Alternatively, if CVMS 119 is not reachable, the call may be terminated on integrated server 160 (which also operates as a call server in such a scenario).

Central voice mail server (CVMS) 119 receives a call request forwarded by call server 115 and enables the caller to store a voice message for the called terminal (party). The CVMS records the voice message and stores the message in the corresponding voice mail box of the called party. The voice mail boxes for various terminals may be stored in data storage 109. CVMS 119 may allow party/terminal to download the voice mail messages from the corresponding voice mail box by using appropriate authentication mechanism (using AAA servers, well known and not shown).

Terminals 191-193 may represent terminal devices such as telephone sets and computer systems, which enable a user to conduct telephone calls as well as interface with voice mail services. Each terminal device may be identified using a unique identifier, which is registered with integrated server 160 (operating as a PVMS, as described below) and CVMS 119 (to identify the specific terminals served by the PVMS/CVMS).

Each terminal may communicate with other terminals, PSTN and voice mail servers using VOIP in a known way. The terminals may also be configured to specify the (IP) addresses of CVMS 119 and integrated server 160. In one embodiment, each terminal polls CVMS 119 and accesses PVMS only if the CVMS is not accessible. In an alternative embodiment, all the access requests to the voice mail messages are routed through PVMS (described below as a part of integrated server 160) and thus the PVMS may intercept and serve the various access requests.

Integrated server 160 provided according to various aspects of the present invention provides the functionality of call server, PVMS and IP router, while utilizing the bandwidth on communication link 116 as described below in further detail.

### 3. Integrated Server

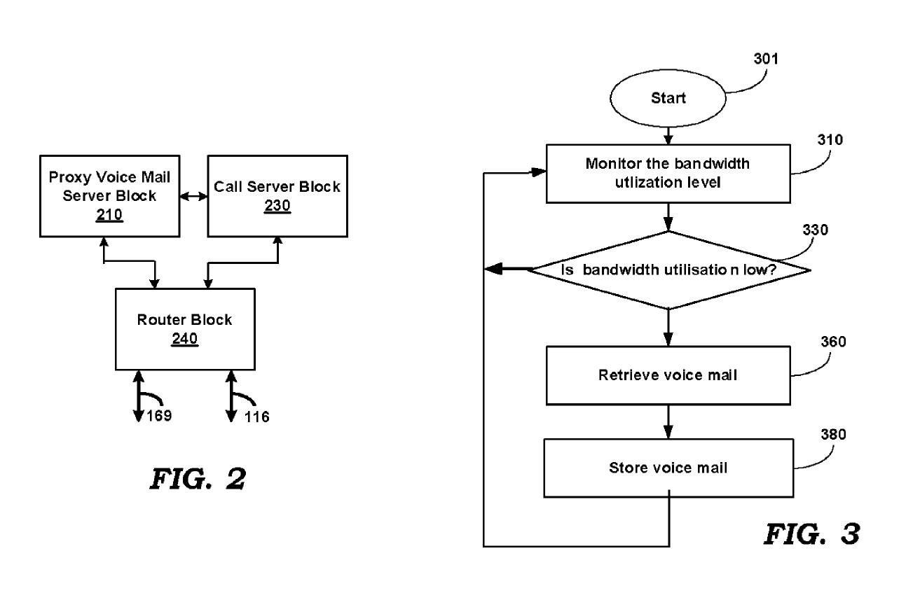

FIG. 2 is a block diagram illustrating the details of integrated server 160 in an embodiment of the present invention. As may be readily observed, proxy voice mail server (PVMS) block 210, call server block 230 and router block 240 are integrated into a single unit. The operation and implementation of each block is described in further detail below.

Router block 240 may receive packets from terminals and corporate premises respectively on paths 169 and 116, and forward each packet on a path determined from the internal routing table. Further, router 240 may store packets in various queues before forwarding on a determined interface/path.

Call server block 230 operates as a backup to call server 115 when connection/link 116 is lost to corporate location. Thus, call server block 230 becomes operational when call server 115 is not reachable. In one embodiment, each terminal 191-193 detects the unavailability of connection 116 and contacts call server block 230 (for call setup, etc.) upon such detection.

Proxy voice mail server (PVMS) block 210 may maintain a record of users (terminals) registered or connected to PVMS 210, and also a copy of authentication data required to authenticate each of the registered users. The authentication data may be retrieved from a AAA server (not shown) and stored locally.

The authentication can be used by PVMS 210 to retrieve stored messages from CVMS 119. In addition, users may be authenticated even if the AAA server (not shown) is provided only in central location 210, and cannot be accessed due to link (116) outages.

Such integration of both PVMS and router block provides various advantages, as described below.

### 4. Down loading Voice Mail Messages

FIG. 3 is a flowchart illustrating the manner in which a PVMS may down load message according to an aspect of present invention. The flowchart is described with respect to FIGS. 1 and 2 merely for illustration. However, the approaches can be implemented in other environments as well. The flowchart begins in step 301, in which control passes to step 310.

In step 310, integrated server 160 monitors the bandwidth utilization of a link (connecting to the corporate premises). For example, integrated server 160 may measure the bandwidth utilization by examining various counters typically maintained associated with the links.

In step 330, integrated server 160 determines whether the utilization is low. The determination may be performed by comparing the utilization level (e.g., the change in a counter value counting the number of bytes transmitted) with a threshold value. Control passes to step 360 if the utilization is low and to step 310 otherwise.

In step 360, integrated server 160 retrieves voice mail messages from central voice mail server 119. Voice mail messages corresponding to each of the users registered with the proxy voice mail server 210 may be down loaded from the central voice mail server 119. Integrated server 160 may use copy of authentication information stored in the PVMS 210 to obtain access to corresponding voice mail boxes.

In step 380, integrated server 160 stores the voice mail messages corresponding to each user in a local storage. Voice mail messages of each user may be stored in the form of voice mail boxes similar to the message storage in the corporate premises. Control then passes to step 310 to update the local mail boxes with any newly arrived messages.

Due to the approach described above, the voice mail messages can be down loaded with a small interval of time without blocking the channel bandwidth to other applications. The messages thus retrieved can then be conveniently played to a user, as described below in further detail.

### 5. Providing Voice Mail Messages

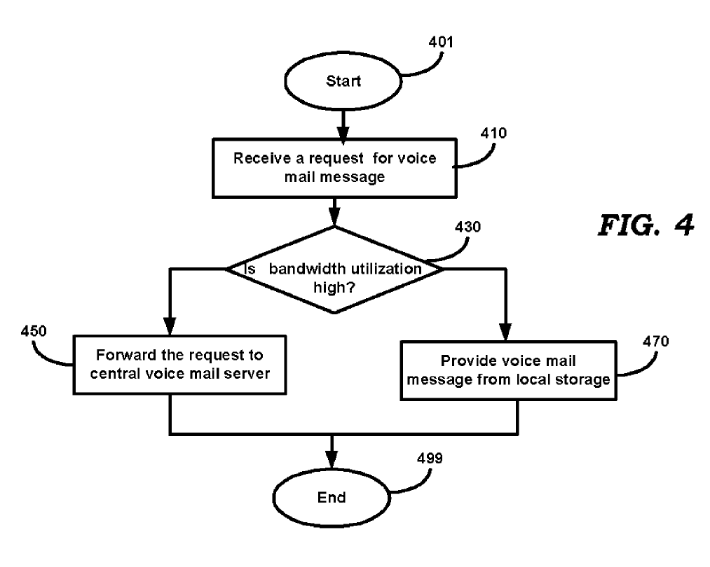

FIG. 4 is a flowchart illustrating the manner in which integrated server 160 provides voice mail messages to the users according to an aspect of present invention. The flowchart is described with respect to FIGS. 1 and 2 merely for illustration. However, the approaches can be implemented in other environments as well. The flow chart begins in step 401 and control immediately passes to step 410.

In step 410, integrated server 160 receives a request for voice mail messages from a user. For simplicity, it is assumed that the user terminals are implemented according to an approach in which all the requests are directed via the PVMS configured in the user terminals. Accordingly, PVMS block 210 may receive the requests. Alternatively (in approaches in which the terminals poll the CVMS and send packets directly to CVMS 119 upon accessibility), due to the integration of PVMS block 210 and the router block 240, the request would be received by integrated server 160.

In step 430, integrated server 160 determines whether bandwidth utilization (on link 116) is high. The determination may be performed similar to step 330 in FIG. 3. Control passes to step 470 if the bandwidth utilization is determined to be high, or else to step 450.

In step 450, integrated server 160 forwards the request to central voice mail server (CVMS) 119. CVMS 119 may then provide the voice mail messages to the user terminal using a suitable interface in a known way. Control then transfers to step 499, in which the flowchart ends.

In step 470, integrated server 160 provides voice mail messages from local storage to the user terminal of step 410. The voice mail messages stored according to step 380 may be provided to the user (terminal 191-193) requesting for voice mail messages. Integrated server 160 may use locally stored copy of authentication data to authenticate the user before providing the voice mail messages from the corresponding local mail box. Control then passes to step 499.

Due to the approach described above, a user may be provided voice mail messages without causing additional overhead on the channel bandwidth at least in situations of high utilization. The features described above can be implemented using various approaches. The description is continued with respect to an example architecture for integrated server 160.

### 6. Integrated Server

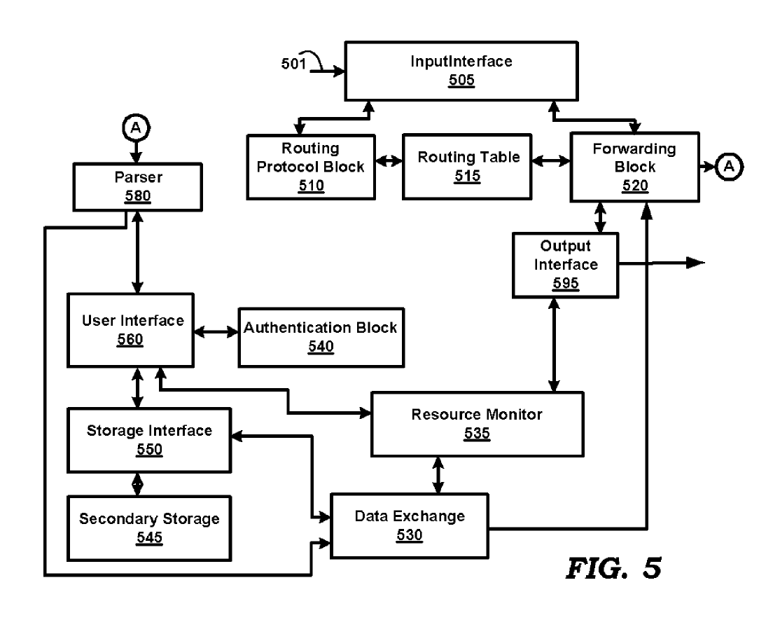

FIG. 5 is block diagram depicting the details of integrated server 160 in an embodiment of the present invention. The server is shown containing input interface 505, routing protocol block 510, routing table 515, forwarding block 520, data exchange block 530, resource monitor block 535, authentication block 540, secondary storage 545, storage interface 550, user interface 560, decision block 570, parser 580 and output interface 595. Each block is described in further detail below.

Input interface 505 provides the physical/electrical/protocol interfaces to enable integrated server 160 to receive IP packets (on the various communication interfaces). Similarly, output interface 595 provides the interfaces to enable the server to send IP packets. Paths 501 and 599 together implement paths 116 and 169 noted above.

Routing protocol block 510, routing table 515, and forwarding block 520 together implement router block 240 noted above. In particular, routing protocol block 510 populates routing table 515 with various forwarding entries, which indicate the specific interface/path on which each received IP packet is to be forwarded.

Forwarding block 520 examines routing table 515 to determine the specific interface on which to forward each received IP packet. If the packet is destined to integrated server 160 (or otherwise requires processing within the server to support various features noted above), the packet is forwarded to parser 580. Otherwise, the packet is forwarded to output interface 595.

Resource monitor 535 monitors various counters (e.g., number of bytes received) and may maintain a receive flag indicating whether the bandwidth utilization (in the received direction) exceeds a pre-specified threshold. A transmit flag is similarly maintained to indicate whether the bandwidth utilization in the transmit direction exceeds another pre-specified threshold. The flags may also be set based on other parameters such as round-trip time, jitter, etc. The flags may be updated periodically with a small interval (e.g., every minute) based on the change of counter values.

Data exchange module 530 downloads voice mail messages from CVMS 119 if the receive flag in resource monitor 535 indicates low bandwidth utilization. Only the new messages stored in CVMS 119 may be downloaded (incrementally). Only messages related to the users served by integrated server 160 may be downloaded, and the list of such users may be ascertained based on data stored in secondary storage 545. The downloaded messages are stored in secondary storage 545 via storage interface 550.

Similarly, data exchange module 530 may forward (any) newly recorded voice mail messages for any of the registered users to CVMS 119 when the transmit flag indicates low bandwidth utilization. In general, the download and uploads are designed to synchronize (including deletions after a user deletes the messages) the voice mail messages, and such synchronization may be performed in a known way.

Authentication block 540 authenticates each user based on information such as user identifier and password received from the user. The necessary data may be retrieved a priori from a AAA server (not shown, but well known in the relevant arts), and stored locally.

Parser 580 receives packets from forwarding block 520 and determines whether to forward each packet to data exchange 530 or user interface 560. Packets related to download of voice mail messages are forwarded to data exchange block 530, and packets during the user interaction to download messages (or manage voice mail otherwise) are forwarded to user interface 560.

User interface block 560 receives a request for accessing voice mail messages from a user, and forwards the request to CVMS 119 via forwarding block 520 if the receive flag (maintained at resource monitor 535) indicates low bandwidth utilization. If the receive flag indicates high bandwidth utilization, user interface 560 extracts the voice mail messages from the secondary storage 545 via storage interface 550. However, the user requests may be processed after authenticating the user by interface with the authentication block 540.

User interface block 560 may also enable external users calling terminals 191-193 to record messages. The recorded messages are stored in secondary storage 545 via storage interface 550. The recorded messages may be uploaded at a suitable time to CVMS, as described above.

It should be appreciated that the features described above may be implemented in various combinations of hardware, software and firmware, depending on the corresponding requirements. The description is continued with respect to an embodiment in which the features are operative upon execution of the corresponding software instructions.

### 7. Software Implementation

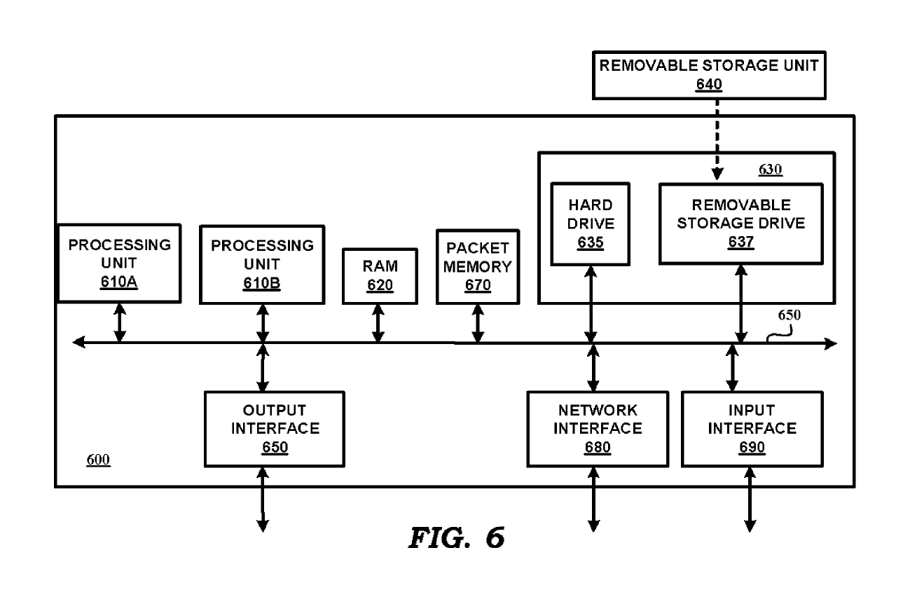

FIG. 6 is a block diagram illustrating the details of digital processing system 600 in one embodiment. System 600 may correspond to integrated server 160. System 600 is shown containing processing unit 610, random access memory (RAM) 620, secondary memory 630, output interface 660, packet memory 670, network interface 680 and input interface 690. Each component is described in further detail below.

Input interface 690 (e.g., interface with a key_board and/or mouse, not shown) enables a user/administrator to provide any necessary inputs to system 600. Output interface 660 provides output signals (e.g., display signals to a display unit, not shown), and the two interfaces together can form the basis for a suitable user interface for an administrator to interact with system 600.

Network interface 680 may enable system 600 to send/receive data packets to/from other systems on corresponding paths using protocols such as internet protocol (IP). Network interface 680, output interface 660 and input interface 690 can be implemented in a known way.

RAM 620, secondary memory 630, and packet memory 670 may together be referred to as a memory. RAM 620 receives instructions and data on path 650 (which may represent several buses) from secondary memory 630, and provides the instructions to processing unit 610 for execution.

Packet memory 670 stores (queues) packets waiting to be forwarded (or otherwise processed) on different ports/interfaces. Secondary memory 630 may contain units such as hard drive 635 and removable storage drive 637. Secondary memory 630 may store the software instructions and data (including the voice mail messages stored by PVMS), which enable system 600 to provide several features in accordance with the present invention.

Some or all of the data and instructions may be provided on removable storage unit 640 (or from a network using protocols such as Internet Protocol), and the data and instructions may be read and provided by removable storage drive 637 to processing units 610. Floppy drive, magnetic tape drive, CD_ROM drive, DVD Drive, Flash memory, removable memory chip (PCMCIA Card, EPROM) are examples of such removable storage drive 637.

Processing unit 610 may contain one or more processors. Some of the processors can be general purpose processors which execute instructions provided from RAM 620. Some can be special purpose processors adapted for specific tasks (e.g., for memory/queue management). The special purpose processors may also be provided instructions from RAM 620. In general, processing unit 610 reads sequences of instructions from various types of memory medium (including RAM 620, storage 630 and removable storage unit 640), and executes the instructions to provide various features of the present invention described above.

### 8. Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. An integrated server comprising:
a switching block receiving a plurality of packets and determining a specific one of a plurality of paths on which to forward each of said plurality of packets; and
a proxy voice mail server block (PVMS block) operating as a backup to a central voice mail server (CVMS), wherein said PVMS block receives some of said plurality of packets from said PVMS via said switching block.

2. The integrated server of claim 1, wherein said PVMS block retrieves a plurality of voice mail message stored in said CVMS and provides said plurality of voice mail messages to a user said PVMS is configured to serve.

3. The integrated server of claim 2, wherein said PVMS block is connected to said CVMS by a communication link, wherein said PVMS synchronizes voice mail messages when bandwidth utilization on said communication link is below a threshold.

4. The integrated server of claim 3, further comprising a memory to store said voice mail messages, wherein said PVMS block receives a request to access a voice mail message from a user and forwards said request to said CVMS only when bandwidth utilization on said communication is below a threshold.

5. A method of providing voice mail services to a user, said method being performed in a proxy voice mail server (PVMS) which operates as a backup to a central VMS (CVMS), said method comprising:
monitoring a bandwidth utilization on a communication path connecting said PVMS to said CVMS; and
downloading a plurality of voicemail messages from said CVMS if said bandwidth utilization is below a threshold.

6. The method of claim 5, further comprising:
receiving a call to said user, wherein said call is terminated at said PVMS when said CVMS is not accessible to terminate said call;
recording a voice mail message on said PVMS; and
uploading said voice mail message to said CVMS if said bandwidth utilization is below said threshold.

7. A method of providing voice mail services to a user, said method being performed in a proxy voice mail server (PVMS) which operates as a backup to a central VMS (CVMS), said method comprising:
monitoring a bandwidth utilization on a link connecting said PVMS to said CVMS;
receiving a request from said user to access a plurality of voicemail messages; and
forwarding said request to said CVMS if said bandwidth utilization is below a threshold and providing a plurality of messages to said user from a local secondary storage otherwise.

8. The method of claim 7, wherein said plurality of voicemail messages are downloaded from said CVMS when said bandwidth utilization is below another threshold.
